(19) United States
(12) Patent Application Publication
(10) Pub. No.: US 2007/0237509 A1
(43) Pub. Date: Oct. 11, 2007

(54) Method and Apparatus for Controlling an Image Capturing Device

(76) Inventor: Wen-Ching Ho, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/459,024

(22) Filed: Jul. 21, 2006

(30) Foreign Application Priority Data
Apr. 11, 2006 (TW) 095112837

(51) Int. Cl. G03B 17/00

(52) U.S. Cl. 396/56

(57) ABSTRACT

A method for controlling an image-capturing device for synchronizing a camera module and a receiver when capturing images includes enabling a synchronization signal after receiving a snap shot request from the receiver, resetting the synchronization signal and triggering the camera module to capture an image after the camera module finish configuring operation settings, and receiving the image shot by the camera module with the receiver after a predetermined number of frames from a time of resetting the synchronization signal.

### BACKGROUND OF THE INVENTION

1. Field of the Invention

The invention relates to a method and apparatus for controlling an image capturing device, and more particularly, to a method and apparatus for synchronizing a camera module and a receiver through a software.

2. Description of the Prior Art

As the information industry progresses, digital products such as digital cameras are gradually replacing conventional analog products. Conventional cameras typically use photo-sensing chemicals on a film to record images. Usually the said conventional film requires a complicated development processes to reproduce the images. In contrast to conventional cameras, digital cameras capture images digitally by utilizing photo-sensors to convert images into digital signals and then store the digital signals in a memory. Users are able to utilize image processing tools to process the images stored in the digital camera and obtain special effects that can never be achieved from conventional cameras. Additionally, as the technology for chips and optics advances, various portable electronic devices today, including notebook computers, cellular phones, personal digital assistants (PDAs) also include built-in digital cameras for the users' convenience.

Please refer to FIG. 1. FIG. 1 is a block diagram illustrating an image-capturing device 10 of a portable electronic product according to the prior art. As shown in FIG. 1, the image-capturing device 10 includes a camera module 100 and a receiver 106. The receiver 106 functions to receive commands from the users, control operations such as photo-taking, recording and image processing of the camera module 100, and to store or playback the images captured by the camera module 100. The camera module 100 includes an image sensor 102 and an image processing unit 104. The image sensor 102 functions to capture light waves of an image through a lens (not shown) and convert the light waves into electrical signals. The image processing unit 104 is responsible for processing image signals, such as format conversion, color adjustment, auto white balance, and auto exposure. The processing time of the image processing unit 104 varies with the resolution, shutter speed, format of the image (such as RGB or JPEG), and status of the flash being used. Preferably, the image processing unit 104 includes a synchronization circuit 108 to synchronize the receiver 106 and remind the receiver 106 to receive data.

By utilizing the image-capture device 10, users are able to engage in activities involving image-capturing through the portable electronic device freely. However, as the receiver 106 is often unaware of when to start receiving image data, the image processing unit 104 must include the synchronization circuit 108 to trigger the receiver 106 to start receiving image data, which ultimately increases the overall cost of the device. Moreover, since the synchronization circuit 108 becomes even more complex as different image formats require different operating sequences, the cost of the device is further increased. It is apparent that new and innovative techniques and devices are needed to solve the above mentioned problems.

### SUMMARY OF THE INVENTION

It is therefore an objective of the present invention to provide a method and apparatus for controlling an image-capturing device.

A method for controlling an image-capturing device for synchronizing a camera module and a receiver when capturing images is disclosed. The method includes: enabling a synchronization signal after receiving a snap shot request from the receiver; resetting the synchronization signal and triggering the camera module to capture an image after operation settings of the camera module are configured; and receiving the image shot by the camera module with the receiver after a predetermined number of frames from a time of resetting the synchronization signal.

A controller for an image-capturing device is disclosed, in which the controller synchronizes a camera module and a receiver while capturing images. The controller includes a microprocessor for executing a program code and a memory for storing the program code. The program code includes: enabling a synchronization signal after receiving a snap shot request from the receiver; resetting the synchronization signal and triggering the camera module to capture an image after the camera module finishes configuring operation settings; and receiving the image shot by the camera module with the receiver after a predetermined number of frames from a time of resetting the synchronization signal.

A method for controlling an image-capturing device is disclosed. The method includes: sending a snap shot request to a camera module; determining whether a first synchronization signal is being reset; determining whether a second synchronization signal is being converted while the first synchronization signal is being reset; and receiving an image output by the camera module while the second synchronization signal is being converted.

A controller for a data receiver of an image-capturing device is disclosed. The controller includes a microprocessor for executing a program code and a memory for storing the program code. The program code includes: sending a snap shot request to a camera module; determining whether a first synchronization signal is being reset; determining whether a second synchronization signal is being converted while the first synchronization signal is being reset; and receiving an image output by the camera module while the second synchronization signal is being converted.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an image-capturing device of a portable electronic product according to the prior art.

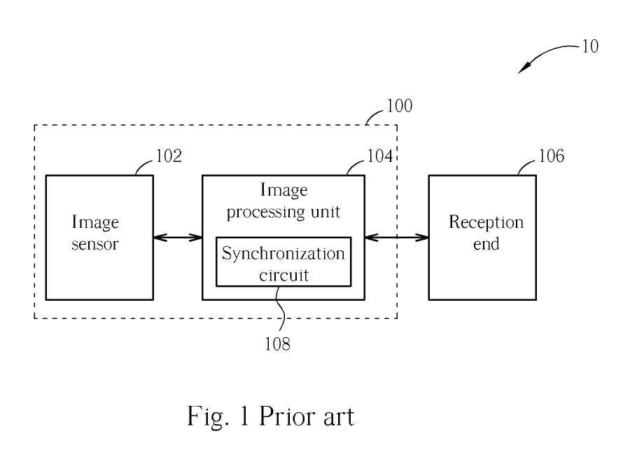

FIG. 2 is a block diagram illustrating an image-capturing device according to an embodiment of the present invention.

FIG. 3 is a flowchart diagram showing an image-capturing workflow according to an embodiment of the present invention.

FIG. 4 is a flowchart diagram showing an image-capturing workflow according to an embodiment of the present invention.

FIG. 5 is a signal timing diagram of the camera module and the receiver according to the image-capturing workflow from FIG. 4.

### DETAILED DESCRIPTION

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

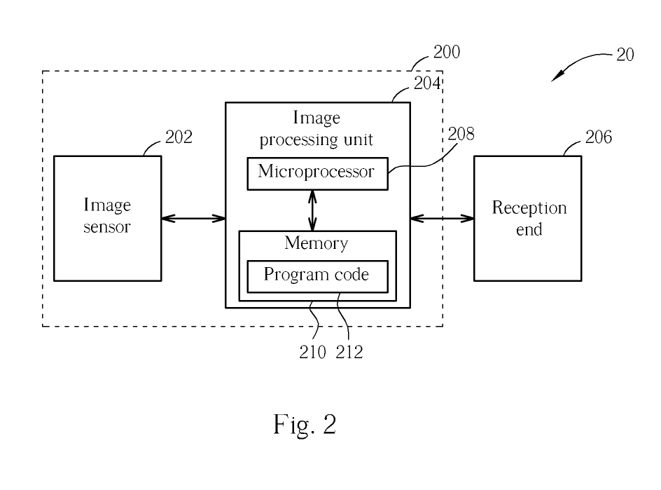

Please refer to FIG. 2. FIG. 2 is a block diagram illustrating an image-capturing device 20 according to an embodiment of the present invention, in which the image-capturing device 20 can be embedded within a portable electronic device. As shown in FIG. 2, the image-capturing device 20 includes a camera module 200 and a receiver 206. The receiver 206 functions to receive commands from the users, control operations such as photo-capturing, recording and image processing of the camera module 200, and stores or playbacks the images captured by the camera module 200. The camera module 200 includes an image sensor 202 and an image processing unit 204. The image sensor 202 functions to capture light waves of an image through a lens and convert the light waves into electrical signals. The image processing unit 204 is responsible for processing image signals, such as format conversion, color adjustment, auto white balance, and auto exposure. The image processing unit 204 includes a microprocessor 208 and a memory 210. The microprocessor 208 is utilized to execute a program code 212 stored in the memory 210 to synchronize the camera module 200 and the receiver 206, thereby triggering the receiver 206 to start receiving image data.

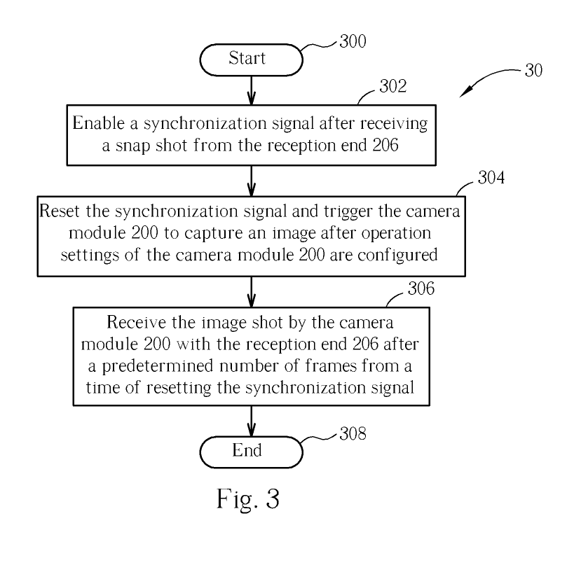

Please refer to FIG. 3. FIG. 3 is a flowchart diagram showing an image-capturing workflow 30 according to an embodiment of the present invention. Preferably, the image-capturing workflow 30 can be compiled into the program code 212 for synchronizing the camera module 200 and the receiver 206 while images are being captured. The image-capturing workflow 30 includes the following steps:

Step 300: Start.

Step 302: Enable a synchronization signal after receiving a snap shot request from the receiver 206.

Step 304: Reset the synchronization signal and trigger the camera module 200 to capture an image after operation settings of the camera module 200 are configured.

Step 306: Receive the image shot by the camera module 200 with the receiver 206 after a predetermined number of frames from a time of resetting the synchronization signal.

Step 308: End.

According to the image-capturing workflow 30, the synchronization signal is enabled, such as converting to a higher status after the snap shot request from the receiver 206 is received. After the operation settings of the camera module 200 are configured, the synchronization signal is being reset, such as converting to a lower status. After a predetermined number of frames, the image taken by the camera module 200 is received from the receiver 206. Preferably, the phase during which the synchronization signal is enabled is utilized to adjust the settings of the camera module 200, such as the mode of photo-capturing and other special effects. After the synchronization signal returns to the reset state, the flash can be fired to compensate for the existing light or for additional lighting effects. Hence, by utilizing the microprocessor 208 to execute the program code 212 stored in the memory 210, the present invention can enable the synchronization signal while the shutter is pressed for adjusting the settings of the camera module 200, including different photo-capturing modes and special effects. After the settings are adjusted, the synchronization signal is reset to initiate a flash for taking a picture. After a predetermined number of frames pass, the receiver 206 is utilized to receive the image captured by the camera module 200.

Depending on different resolution, shutter speed, or image format (such as RGB or JPEG) utilized, or whether the flash is turned on, the processing time required by the image processing unit 204 can also vary accordingly. Hence, by utilizing the present invention, the microprocessor 208 is able to trigger the receiver 206 to start receiving image data after the synchronization signal is reset and after a predetermined number of frames pass, such that the receiver 206 is able to determine which frame was the flash being fired, thereby preventing the time delay between different modes. More importantly, by implementing the present invention through a means of software to achieve a mechanism for synchronizing the camera module 200 and the receiver 206, the present invention is able to reduce the cost of fabricating a synchronized circuit commonly found in conventional art. Additionally, the present invention can be applied in different image formats.

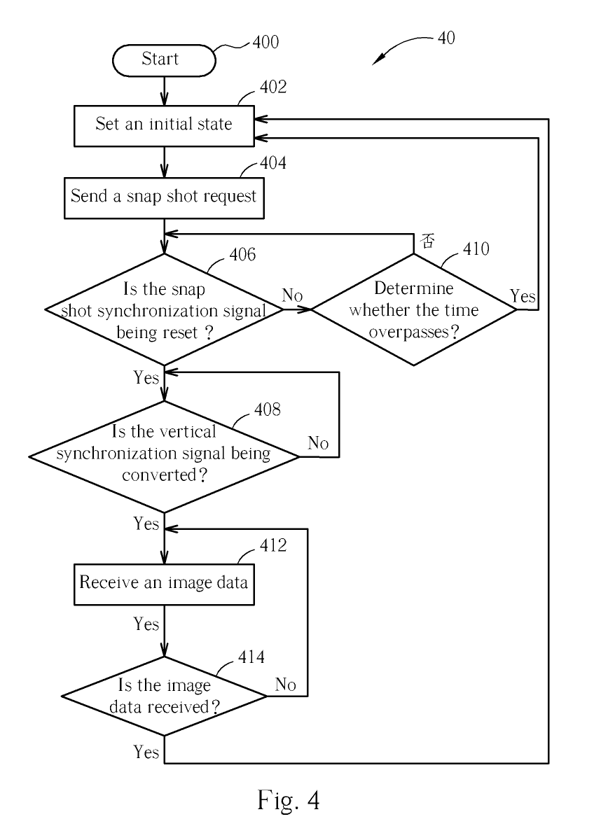

Please refer to FIG. 4. FIG. 4 is a flowchart diagram showing an image-capturing workflow 40 according to an embodiment of the present invention. Preferably, the image-capturing workflow 40 can be compiled into the program code 212 for controlling the receiver 206 and synchronizing the camera module 200 and the receiver 206 while images are being captured. The image-capturing workflow 40 includes the following steps:

Step 400: Start.

Step 402: Set an initial state.

Step 404: Send a snap shot request to the camera module 200.

Step 406: Determine whether a snap shot synchronization signal is being reset. If yes, proceed to Step 408, otherwise proceed to Step 410.

Step 408: Determine whether a vertical synchronization signal is being converted. If yes, proceed to Step 412, otherwise remain idle.

Step 410: Determine whether the time overpasses, if yes, return to Step 402, otherwise return to Step 406.

Step 412: Receive an image data.

Step 414: Determine whether the image data is received. If yes, return to Step 402, otherwise return to Step 412.

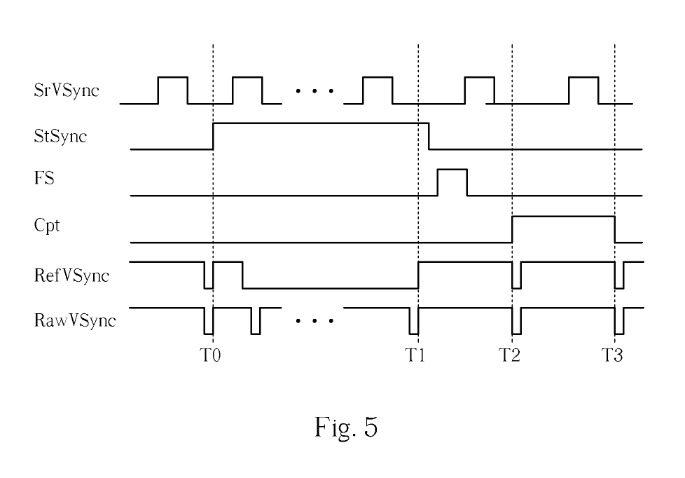

The image-capturing workflow 40 is explained in further detail in FIG. 5. Please refer to FIG. 5. FIG. 5 is a signal timing diagram of the camera module 200 and the receiver 206 according to the image-capturing workflow 40. As shown in FIG. 5, the symbols from top to bottom indicate the vertical synchronization signal SrVsync of the image sensor 202, the snap shot synchronization signal StSync, the flash signal FS, the receiving control signal Cpt of the receiver 206, the vertical synchronization signal RefVSync of the receiver 206 under a reference mode, and a vertical synchronization signal RawVSync of the receiver 206 under a RAW mode. As shown in FIG. 5, when a user presses the shutter at time T0, the receiver 206 will send a snap shot request to the camera module 200 and in the mean time, the snap shot synchronization signal StSync will be enabled. Time T0 through time T1 indicates a duration when different settings such as image-capturing modes and special effects are adjusted by the image processing unit 204. After time T1, the snap shot synchronization signal StSync is returned to a reset state, and the flash signal FS is enabled and ready to fire. It should be noted that the receiver 206 will keep determining whether the snap shot synchronization signal StSync is being reset. As shown in FIG. 5, after the receiver 206 detects that the snap shot synchronization signal StSync is returned to a reset state at time T1 and time T2, the next frame will begin to receive the image data. Hence, at time T2, the receiving control signal Cpt is enabled to control the receiver 206 to start receiving the image data. It should be noted that under a reference mode, such as a JPEG format, and when the vertical synchronization signal RefVSync is in a high state, the data are invalid. If the transmission of data strings is shut down to facilitate an internal data conversion, the vertical synchronization signal RefVSync should be maintained in a low state. Hence, the receiver 206 will only start to receive image data after detecting the next frame of the frame where the snap shot synchronization signal StSync returns to the reset state. By doing so, despite the fact that the camera module 200 is operating under a reference mode or a raw mode, such as a YUYV or RGB format, the receiver 206 can synchronize for both modes with the camera module 200.

By utilizing the present invention, users are able to utilize the receiver 206 to output a snap shot request to the image processing unit 204, and the microprocessor 208 of the image processing unit 204 will convert a snap shot synchronization signal to a high state according to the program code 212 within the memory 210. After the microprocessor 208 adjusts different settings of format conversion, color adjustment, auto white balance, and auto exposure, the snap shot synchronization signal is converted to a low state to initiate the flash. Subsequently, the receiver 206 will receive the image taken by the camera module 200 at the frame next to the one where the snap shot synchronization signal is converted to a low state.

Overall, the method disclosed by the present invention can be incorporated in an image-capturing device, a synchronized digital camera module, and a receiver. The image-capturing device can be embedded into a portable electronic device, such as a notebook computer, a cellular phone, or a personal digital assistant (PDA). Depending on different resolution, shutter speed, and image format (such as RGB or JPEG) utilized and whether the flash is turned on, the processing time for the image processing unit of the digital camera module will also vary significantly. Hence, in order to prevent problems such as inconsistent time delays, the receiver will continue to determine whether the image processing unit of the camera module finishes configuring the operation settings of the camera after sending the snap shot request to the camera module. After the operation settings are configured, the receiver will start receiving the image taken by the camera module after a predetermined number of frames pass. Hence, by utilizing the present invention, synchronization can be achieved for both the camera module and the receiver despite which resolution, shutter speed, or image format is utilized or whether the flash is turned on. Moreover, by implementing the present invention via software approach, the present invention is able to significantly reduce cost and size of the product, and improve the problems caused by the conventional method.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling an image-capturing device for synchronizing a camera module and a receiver while capturing images, the method comprising:
enabling a synchronization signal after receiving a snap shot request from the receiver;
resetting the synchronization signal and triggering the camera module to capture an image after operation settings of the camera module are configured; and
receiving the image shot by the camera module with the receiver after a predetermined number of frames from a time of resetting the synchronization signal.

2. The method of claim 1 further comprising initiating a flash while resetting the synchronization signal and triggering the camera module after the camera module finishes configuring operation settings.

3. The method of claim 1, wherein the predetermined number is one.

4. The method of claim 1 further comprising operating the camera module under a reference mode.

5. The method of claim 1 further comprising operating the camera module under a raw mode.

6. A controller for an image-capturing device, wherein the controller synchronizes a camera module and a receiver while capturing images, the controller comprising:
a microprocessor for executing a program code; and
a memory for storing the program code, the program code comprises:
enabling a synchronization signal after receiving a snap shot request from the receiver;
resetting the synchronization signal and triggering the camera module to capture an image after the camera module finishes configuring operation settings; and
receiving the image shot by the camera module with the receiver after a predetermined number of frames from a time of resetting the synchronization signal.

7. The controller of claim 6, wherein the program code comprises initiating a flash after resetting the synchronization signal, triggering the camera module, and after the camera module finishes configuring operation settings.

8. The controller of claim 6, wherein the predetermined number is one.

9. The controller of claim 6, wherein the camera module is operated under a reference mode.

10. The controller of claim 6, wherein the camera module is operated under a raw mode.

11. A method for controlling an image-capturing device, the method comprising:
sending a snap shot request to a camera module;
determining whether a first synchronization signal is being reset;
determining whether a second synchronization signal is being converted while the first synchronization signal is being reset; and
receiving an image output by the camera module while the second synchronization signal is being converted.

12. The method of claim 11 further comprising determining whether a time of determining whether the first synchronization signal is being reset exceeds a predetermined time before the first synchronization signal is being reset.

13. The method of claim 12 further comprising determining whether the first synchronization signal is being reset after the time of determining whether the first synchronization signal is being reset does not exceed the predetermined time.

14. The method of claim 11, wherein the camera module is operated under a reference mode.

15. The method of claim 11, wherein the camera module is operated under a raw mode.

16. A controller for a data receiver of an image-capturing device, comprising:
a microprocessor for executing a program code; and
a memory for storing the program code, the program code comprising:
sending a snap shot request to a camera module;
determining whether a first synchronization signal is being reset;
determining whether a second synchronization signal is being converted while the first synchronization signal is being reset; and
receiving an image output by the camera module while the second synchronization signal is being converted.

17. The controller for a data receiver of an image-capturing device of claim 16 further comprising determining whether a time of determining whether the first synchronization signal is being reset exceeds a predetermined time before the first synchronization signal is being reset.

18. The controller for a data receiver of an image-capturing device of claim 17 further comprising determining whether the first synchronization signal is being reset after the time of determining whether the first synchronization signal is being reset does not exceed the predetermined time.

19. The controller for a data receiver of an image-capturing device of claim 16, wherein the camera module is operated under a reference mode.

20. The controller for a data receiver of an image-capturing device of claim 16, wherein the camera module is operated under a raw mode.
